(19) United States
(12) Patent Application Publication
(10) Pub. No.: US 2008/0236859 A1
(43) Pub. Date: Oct. 2, 2008

(54) PROTECTIVE DEVICE PLATE FOR AN ELECTRICAL BOX

(75) Inventor: Ian Rubin de la Borbolla, Memphis, TN (US)

Correspondence Address: HOFFMANN & BARON, LLP, 6900 JERICHO TURNPIKE, SYOSSET, NY, 11791, US

(73) Assignee: THOMAS & BETTS INTERNATIONAL, INC., Wilmington, DE (US)

(21) Appl. No.: 12/054,952

(22) Filed: Mar. 25, 2008

Related U.S. Application Data
(60) Provisional application No. 60/920,624, filed on Mar. 29, 2007.

(51) Int. Cl. H02G 3/14

(52) U.S. Cl. 174/66

(57) ABSTRACT

A protective cover for an electrical device mounting structure that includes a generally rectangular plate defined by a perimetrical edge and having a front side, a back side, a right side, a left side, a top and a bottom. The protective cover can also include one or more tabs extending from the back side for engaging the edge of the electrical device mounting structure and one or more openings in the plate for receiving a fastener for affixing the protective cover to the electrical device mounting structure.

This application claims priority from provisional application Ser. No. 60/920,624, filed on Mar. 29, 2007, which is incorporated herein in its entirety.

### FIELD OF THE INVENTION

The present invention relates to a protective plate for covering an electrical box or mud ring. More particularly, the invention relates to an easily installed and removed protective plate for covering an electrical box or mud ring during construction.

### BACKGROUND OF THE INVENTION

In new wall constructions, electrical receptacle boxes and/or mud rings are typically installed on wall studs before the wallboard or sheetrock material is attached to the studs. Wallboard material typically used in residential and commercial installations is formed by a solid gypsum core product with a paperboard covering. Most commonly, it is used in 4′×8′ sheets with thicknesses ranging between ⅜″ to ¾″, although other dimensions are available such as 4′×10′ and 4′×12′ sheets. In one type of installation, the openings for electrical boxes or mud rings are cut in the wallboard before the wallboard is installed. The openings are cut so that they align with the stud mounted electrical boxes or mud rings once the wallboard is attached to the studs. However, this requires measuring and cutting each opening and is fairly time consuming and inefficient.

In order to increase the speed and efficiency of construction, contractors have begun installing uncut wallboard sheets over the stud mounted electrical boxes and mud rings without precutting the openings. After the wallboard is attached, the installer cuts openings in the wallboard, either with a power tool, handsaw or knife, at locations which correspond to the position of the electrical boxes or mud rings. The openings are commonly cut with a tool known as a Roto Zip™, manufactured by Roto Zip Tool Corportion, which has a high speed rotating shaft. The rotating shaft punctures the wallboard at an angle substantially perpendicular to the surface of the wallboard. The rotating shaft is then moved around the perimeter of the opening in the electrical box or mud rings in a manner similar to a router. The rotating shaft cuts an opening in the wallboard corresponding to the dimensions and location of the opening in the electrical box or mud ring. A manual sheetrock saw or knife can also be used to cut a hole in the wallboard after wallboard is installed over the stud mounted electrical box or mud ring. In this method, an initial opening is cut in the wallboard at the location of the electrical box or mud ring and the opening in the electrical box or mud ring is used as a template for cutting the opening in the wall.

While either method can be used satisfactorily to provide an opening in the wallboard for accessing the interior of the electrical box or mud ring, both methods can potentially damage the electrical box or mud ring or any wiring or devices inside. This can result in cut wires or require replacement of damaged electrical boxes or mud rings and/or devices.

The protective plates that are currently being used are attached to the assembly (i.e., the box and receptacle or the mud ring and receptacle) using multiple screws to attach the plate to either the mud ring or the receptacle. The receptacle apertures are the apertures typically used for the final decorative faceplate screws. Some of the protective plates currently in use are made from plastic and they are secured to the box or mud ring either with screws or spring clips that engage the opposing interior walls of the box or mud ring. Some other prior art protective plates fit only one style of mud ring or box and a user has to purchase a separate plate for each different receptacle due to hole locations and component geometry.

Accordingly, it is an object of this invention to provide a protective cover plate that can be attached to a mounted metal box or mud ring with or without a receptacle already installed inside the box or mud ring. The cover will most advantageously have a universal fit to cover a variety of different receptacles (e.g., GFCI, duplex, single and switches) and be compatible with both electrical boxes and mud rings. It is also an object to provide a protective cover plate that can be fastened to a mud ring with securing screws positioned at different locations on the cover.

It is a further object of this invention to provide a protective cover for an electrical box or mud ring that can be temporarily affixed prior to the installation of the wallboard. The protective cover would provide protection to the electrical box and receptacle or mud ring and receptacle while an access opening is cut in the wallboard and then be easily removable.

### SUMMARY OF THE INVENTION

The present invention is a protective cover for an electrical device mounting structure. The protective cover includes a generally rectangular plate having a front and a back and includes a right side wall, a left side wall, a top end wall and a bottom end wall extending downwardly from the front to form a perimetrical edge with four corners. One or more tabs extend downwardly from the perimetrical edge on one or both sides of the plate and there are one or more openings in the plate. The one or more tabs are adapted to engage an edge of the electrical device mounting structure and the one or more openings is adapted to receive a fastener, preferably a screw, for affixing the protective cover to the electrical device mounting structure.

The protective cover can also include a protrusion extending from the front side, which is adapted for gripping the protective cover. In addition, the perimetrical edge can have an outwardly extending lip. Preferably, the one or more tabs extends from the perimetrical edge on the same or opposite sides. The one or more tabs can have an outwardly facing catch for engaging the electrical device mounting structure. The one or more openings are located on the same side of the plate at the corners or in the middle or they are located at diagonally opposed corners. The one or more openings are positioned within a recessed portion of the front and the recessed portion has a base that is not parallel to the plate.

In another embodiment, the protective cover for an electrical device mounting structure includes a generally rectangular plate having a front with a pair of end walls and a pair of side walls extending downwardly from the front of the plate to form a perimetrical edge having four corners. The cover also includes at least one tab that extends downwardly from the perimetrical edge of at least one side wall and at least one recessed portion that includes a base with an aperture which is adapted to receive a securing screw. The at least one tab is adapted to engage a lip around an opening in the electrical device mounting structure and the securing screw is tightened to affix the protective cover to the electrical device mounting structure. The recessed portion can be formed at one of the corners by an indent in the two adjoining walls so that the base is recessed from the front of the plate and slopes downwardly from the side wall. The cover can also include a protrusion that extends from the front of the plate and is adapted for gripping the protective cover.

At least one tab can be located on one side of the cover and the recessed portion can be on the opposing side. Preferably, the at least one tab can have an end that curves away from the cover and is adapted to engage the lip of the mounting structure. Alternatively, the tab can be located on one side of the cover and the recessed portion can be located on the opposing side; preferably, two tabs are on one side of the cover. The tab can be formed by cutting and bending a sheet of metal or by a metal stamping process. The recessed portion is formed by an indent in the side wall and the base is recessed from the front of the plate and slopes downwardly from the side wall. In a preferred embodiment, the cover has two tabs on one side and two securing screws on the opposing side.

In another embodiment, the protective cover includes a generally rectangular plate having a front and a rear. A pair of end walls and a pair of side walls extend downwardly from the front of the plate to form a perimetrical edge with four corners. At least one tab extends downwardly from the perimetrical edge of at least one side wall. The cover also includes at least one recessed portion that has a base with an aperture that is adapted to receive a securing screw. The recessed portion is formed at one of the corners by an indent in the two adjoining walls so that the base is recessed from the front of the plate and slopes downwardly from the side wall. At least one tab is adapted to engage a lip around an opening in the electrical device mounting structure. After the tab engages the lip and the perimetrical edge of the cover is placed over the opening, the securing screw is tightened to affix the protective cover to the electrical device mounting structure.

Preferably, two tabs are located on opposing sides of the cover and are adapted to flexibly engage the lip on opposing sides of the opening in the electrical device mounting structure. Each of the tabs can be located in a notch in the side wall and each can have an outer surface with a catch that is adapted to engage the lip of the electrical device mounting structure. In preferred embodiments, two recessed portions are located at diagonally opposed corners of the cover.

### BRIEF DESCRIPTION OF THE DRAWINGS

FIG. 1 is a front perspective view of a door style protective cover plate with the door in the closed position.

FIG. 1A is a front perspective cut-away view of the door style protective cover plate of FIG. 1.

FIG. 2 is a front perspective view of a door style protective cover plate with the door in the open position.

FIG. 2A is a front perspective cut-away view of a door style protective cover plate FIG. 2.

FIG. 3 is a cut-away end view of a door style protective cover plate with the door in the open position.

FIG. 4 is a cut-away detail of a partially inserted securing screw for a door style protective cover plate.

FIG. 5 is a cut-away end view of a door style protective cover plate with the door in the closed position.

FIG. 6 is a cut-away detail of a fully inserted securing screw for a door style protective cover plate.

FIG. 7 is a side view of a door style protective cover plate with the cover plate in the closed position.

FIG. 8 is a side view of a door style protective cover plate with the cover plate in the open position.

FIG. 9 is a top perspective view of a corner style protective cover plate.

FIG. 10 is a bottom perspective view of a corner style protective cover plate.

FIG. 11 is a perspective top view of a second embodiment of a door style protective cover plate with one securing screw.

### DETAILED DESCRIPTION OF THE PREFERRED EMBODIMENT

The present invention is a protective cover plate for an electrical device mounting structure (e.g., an electrical box or a mud ring) that protects the mounting structure and any electrical device that may be mounted to it from damage during construction. The protective cover plate is designed to be quickly and easily attached to and detached from the mounting structure. The protective cover plate provides protection for the mounting structure and device inside without requiring significant time and effort on the part of the user. The protective cover plate is typically mounted on an installed electrical box or mud ring to protect the box or mud ring when the wall covering is attached.

In one embodiment, the protective cover plate has one or more tabs extending from one side which engage the lip around the opening in the mounting structure and act as a hinge. The opposing side has one or more securing screws that extend under the lip when tightened to secure the cover to the mounting structure. This embodiment is referred to herein as the “door style” protective cover plate or cover. In another embodiment, one or more tabs extend from opposing sides of the protective cover plate and engage the opposing sides of the opening in the mounting structure. One or more securing screws secure the protective cover plate to the mounting structure. This embodiment is referred to herein as the “corner style” protective cover plate or cover.

Both the door style protective cover plate and the corner style protective cover plate have at least one (preferably two) securing screws located at the corners. The door style protective cover plate preferably has the securing screws located in the two adjacent corners opposite the hinged side of the cover and the corner style protective cover plate preferably has the securing screws located in diagonally opposing corners. In other embodiments, the door style protective cover plate has one securing screw located near the middle of the side opposite the hinged side. In both designs, the covers have raised plates and the sides extend downwardly to form a perimetrical edge. In preferred embodiments, the cover contacts the lip around the opening in the mounting structure. The securing screws are preferably located at the corners of the cover plate in recessed portions that are recessed from the front of the raised plate and indented from the adjoining side walls of the cover. The recessed portions are open on two sides and have two walls formed by the adjoining side and end walls. A base has an aperture and is formed on the bottom of the recessed portion at an angle so that it slopes away from the side wall. This arrangement allows the securing screws to pass under the perimetrical edge when fully inserted so that it can more easily engage the mounting structure (e.g., the lip of a mud ring) to secure the cover in place. When a single securing screw is used with the door style design, the recessed portion is located near the middle of the side wall and is enclosed by the side wall on three sides and open on only one side.

The embodiments of the cover differ with respect to the tabs that engage the mounting structure, i.e., the electrical box or mud ring. The door style design has one or more tabs (preferably two) that extends downwardly from one of the side edges and has an end that curves outwardly and upwardly away from the cover. The curved ends slide under the lip of a mud ring and form a hinge-like connection with the lip that allows the cover to pivotably move between an open a closed position.

The corner style design uses the same recessed portions for the securing screws but the tabs extend downwardly from the perimetrical edge on opposing sides of the cover. These tabs are resilient with a catch at the end. The top of the catch extends from the outer side of the tab and tapers inwardly as it approaches the end of the tab. When the cover is placed over the opening in a mounting structure (e.g., a mud ring), the tabs engage the lip on the opposite sides of the opening in the mud ring and flex inwardly until the top of the catch passes under the lip. The securing screws in the recessed portions of diagonally opposed corners of the cover are then tightened to secure the cover in place. The cover can easily be removed by loosening the screws and then applying pressure to the outside surface of one of the tabs with a screwdriver to disengage the catch.

The present invention provides a universal protective cover plate that is easily attached to various types of receptacles and is not limited by the locations of the apertures in a electrical receptacles or a mud rings. The cover plate of the present invention is not secured to these apertures, but instead the cover plate is secured to the inside lip of a mud ring or other mounting structure. Screws on either one (for door style) or two (for corner style) sides can be used in a variety of configurations to secure the cover plate in place. The corner style configuration uses two securing screws in any two of the four corners, preferably two diagonally opposed corners. The screws are inserted through the cover plate at an angle and under the inside lip of the mud ring. This angle is created by the base of the recessed portion which slopes downwardly from the side wall of the cover. The tabs are preferably located on opposing sides of the perimeter edge of the protective plate and align the cover plate in the opening of the electrical box or mud ring.

The door style embodiment can use one securing screw located near the midpoint of the side wall opposite the tabs or it can use two securing screws located at the corners opposite the tabs. The tabs secure the cover plate to the lip on one side of the opening in the mounting structure (generally a box or a mud ring) so that securing screws are not required on both sides of the protective cover plate. One or two screws are typically used to attach the cover plate to a mud ring. However, the invention is not limited by the number of screws that are used. The placement and number of screws can vary and screws can be placed on the outer edges or in one or more corners of the protective plate. The securing screws extend through the cover plate and under the lip of the mounting structure to create a tight interference fit between the protective cover and the mounting structure.

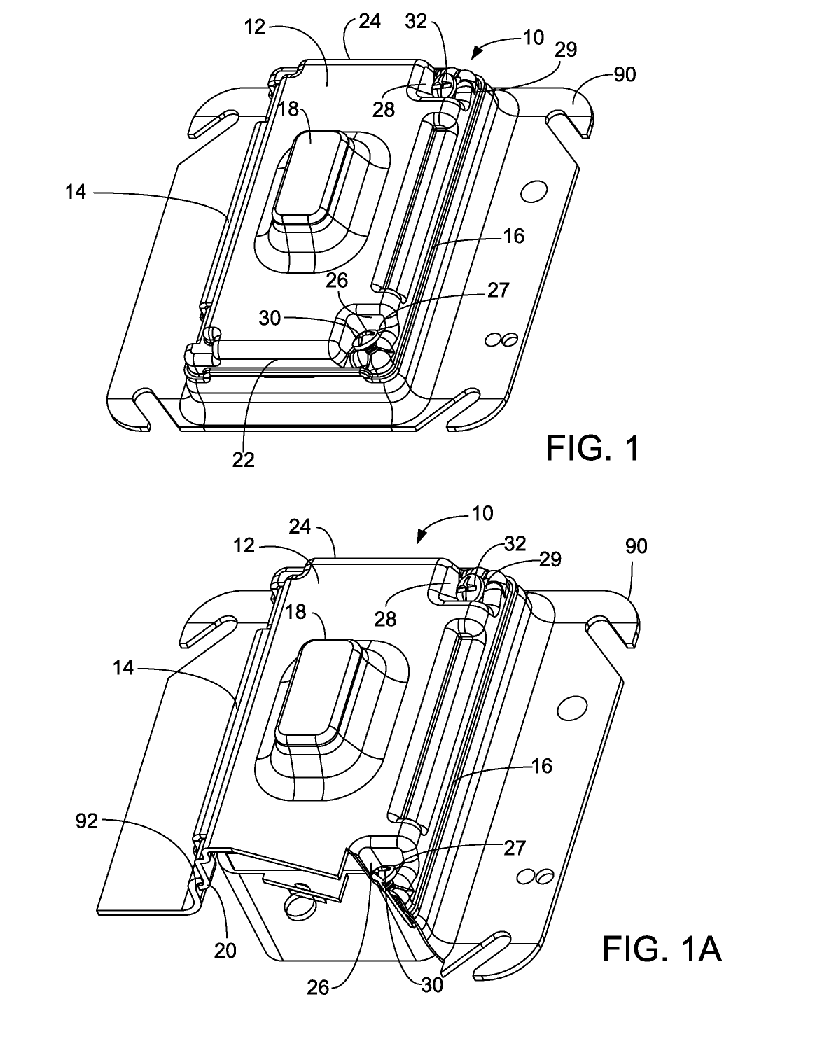

FIG. 1 and FIG. 1A show a door style protective cover plate 10 of the present invention secured to a mud ring 90. FIG. 1A is a cutaway view and shows how the tab 20 and securing screw 30 engage the lip 92 around the opening in the mud ring 90. The cover 10 has a generally rectangular front face plate 12 with a raised finger grip 18 extending from the center, which provides a user with an easily grasped protrusion for installing and removing the protective cover plate 10. The door style protective cover plate 10 includes a pair of tabs 20 extending downwardly form a first side 14 of the cover 10 and a pair of recessed portions 26, 28 located at the corners of the second side 16 of the cover 10. The end of each tab 20 curves outwardly and slide under the lip 92 of the mud ring 90. This allows the cover 10 to pivot between an open and closed position.

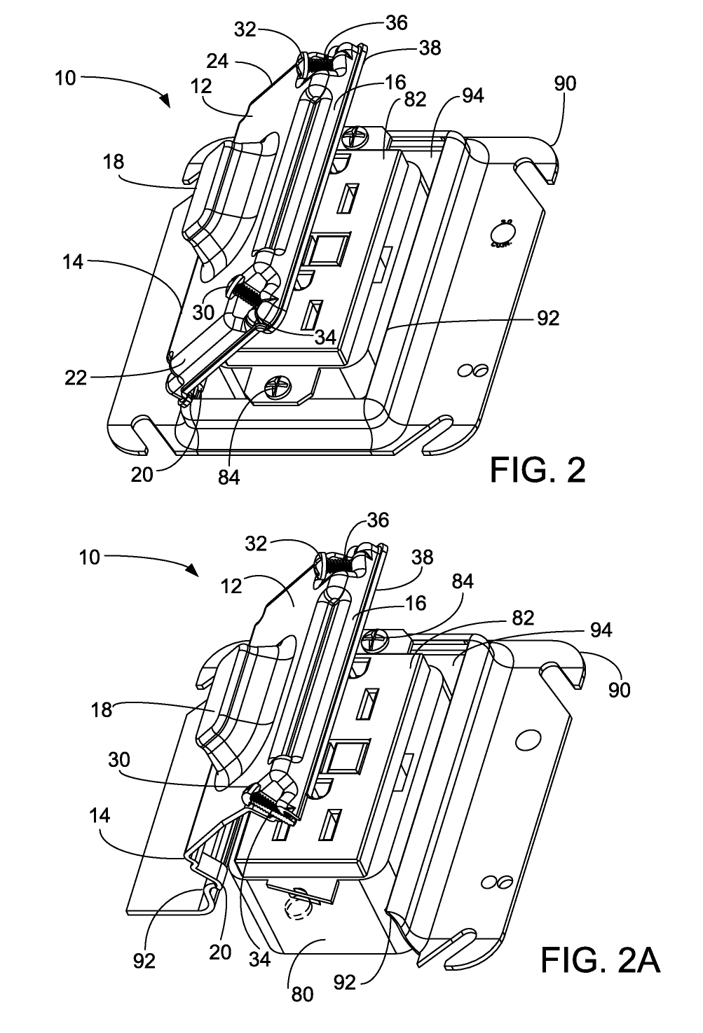

The second side wall 16 slopes downwardly from the front face plate 12 of the cover 10 and forms a side edge 38 (FIG. 2), which contacts the area near the lip 92 around the opening 94 in the mud ring 90. Each of the recessed portions 26, 28 has two side walls and an angled base that includes an aperture 34, 36 for the securing screw 30, 32. The base 27, 29 is angled (FIG. 4) in such a way that when the cover 10 is in the closed position and the screw 30, 32 is inserted, the screw threads pass through the aperture 34, 36 and engage the inside lip 92 of the mud ring 90. The protective cover plate 10 can include additional recessed portions along the side 16 with apertures adapted to receive screws for securing the cover 10.

FIG. 2 and FIG. 2A show a door style protective cover plate 10 attached to a mud ring 90 with the cover 10 in the open position. FIG. 2A is a cut-away view of the cover 10 and illustrates how the tab 20 engages the lip 92 of the mud ring 90 to provide pivotal movement of the cover 10. A receptacle 82 is attached to the side wall 80 of the mud ring 90 by a pair of mounting screws 84. The tabs 20 (only one is visible) engage the lip 92 of the mud ring 90 and the cover 10 pivots downwardly over the opening 94 in the mud ring 90. After the side edge 38 of the cover 10 comes to rest around the lip 92 of the mud ring 90, the securing screws 30, 32 are tightened to engage the lip 92. The cover 10 has a pair of closed ends 22, 24 (FIG. 8) at the top and bottom, which together with the side walls 14, 16, prevent dirt and loose materials from passing under the cover 10.

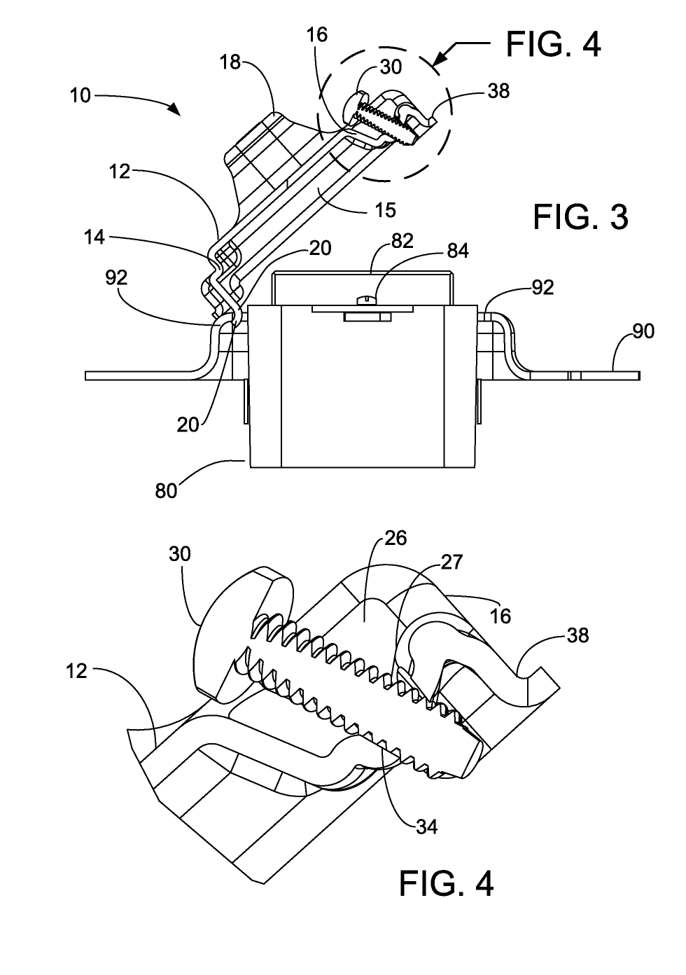

FIG. 3 shows a cut-away end view of the cover 10 shown in FIG. 2 with the receptacle 82 extending beyond the side wall 80 of the mud ring 90. To accommodate the receptacle 82, the front face plate 12 of the cover 10 is raised and the side walls 14, 16 slope downwardly to form a cavity 15. FIG. 3 also shows how the tabs 20 on one side of the cover 10 engage the lip 92 of the mud ring 90. The recessed portion 26 in the corner of the cover 10 and the securing screw 30 are shown in detail in FIG. 4.

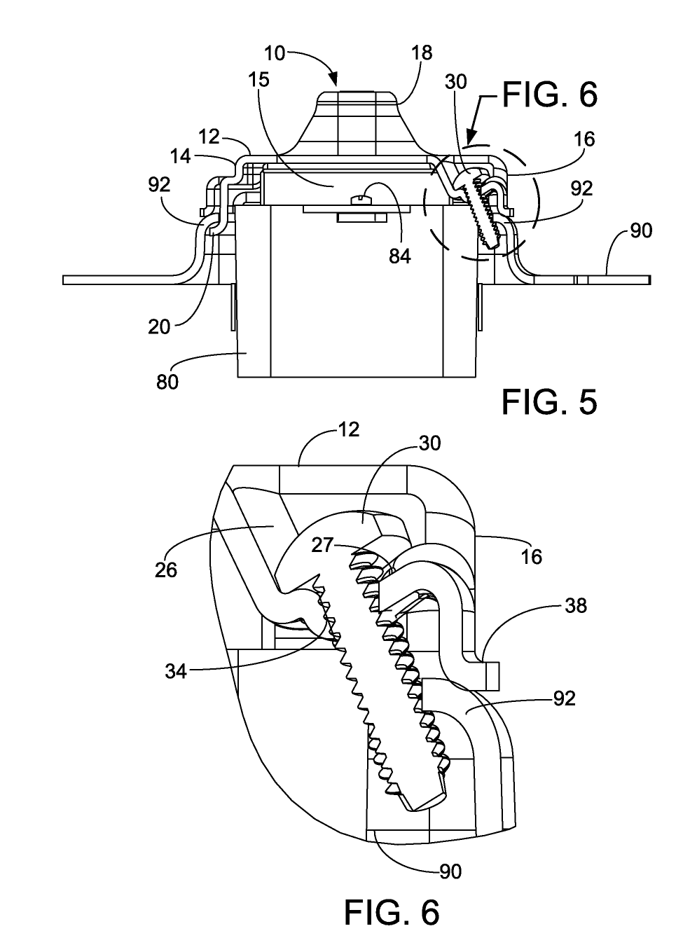

FIG. 4 shows a cut-away detail of how the recessed portion 26 in the corner of the cover 10 is formed below the front face plate 12 of the cover 10. The recessed portion 26 has a base 27 that slopes downwardly from the side wall 16 so that the securing screw 30 passes through the base 27 at an angle. In FIG. 4, the securing screw 30 is only partially inserted in the aperture 34 so that, when the cover 10 is closed onto the mud ring 90, the screw 30 does not interfere. After the cover 10 is closed, the securing screw 30 is fully inserted into the aperture 34 in the base 27 and the end of the screw 30 extends beyond the edge 38 of the cover 10 to engage the lip 92 of the mud ring 90 (FIG. 5).

FIG. 5 is a cut-away end view which shows the cover 10 in the closed position with the securing screw 30 engaging the lip 92 of the mud ring 90. Once the securing screw 30 is tightened, the tabs 20 on the opposing side of the cover 10 are locked into the lip 92 of the mud ring 90. A cavity 15 is formed by the cover 10 above the side wall 80 of the mud ring 90. FIG. 6 is a cut-away detail showing the securing screw 30 of FIG. 5 in the fully inserted position and engaging the lip 92 of the mud ring 90. The edge 38 of the cover 10 contacts the top of the lip 92 and the securing screw 30 engages the inside of the lip 92 to force the edge 38 of the cover 10 against the lip 92.

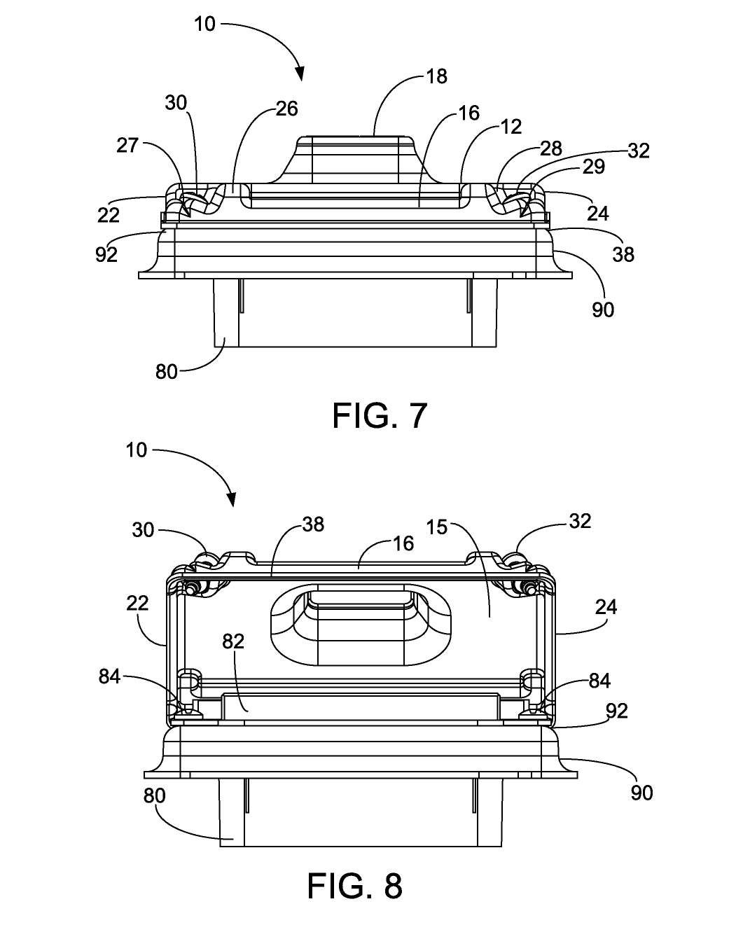

FIG. 7 shows a side view of the cover 10 mounted on a mud ring 90 with the side wall 80 of the mud ring 90 extending from the bottom. The two securing screws 30, 32 in the recessed portions 26, 28 are below the front face plate 12 of the cover 10 and do not extend above the front face plate 12. The bases 27, 29 of the recessed portions 26, 28 are formed at an angle so that, when the securing screws 30, 32 are fully inserted, they extend under the lip 92 of the mud ring 90.

In FIG. 8, the protective cover plate 10 shown in FIG. 7 is in the open position with the cavity 15 on the bottom side of the cover visible. The cavity 15 provides clearance for the portion of the receptacle 82, which extends above the mud ring 90. The receptacle 82 is mounted in the mud ring 90 by a pair of mounting screws 84. The perimetrical edge 38 of the cover 10 contacts the top of the mud ring 90.

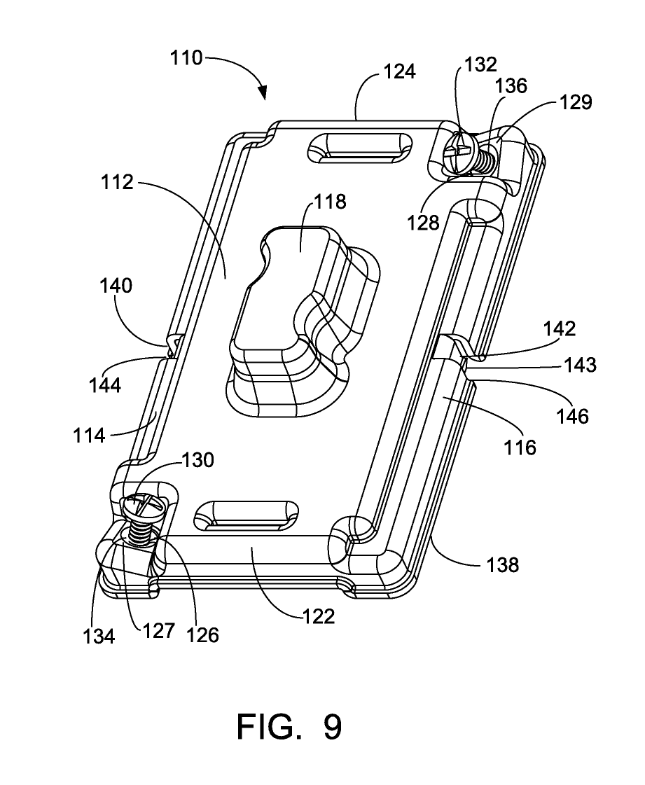

FIG. 9 shows a corner style protective cover plate 110 that has a front face plate 112 with a pair of side walls 114, 116 and a pair of end walls 122, 124 extending downwardly to form a perimetrical edge 138. In this embodiment of the invention, two tabs 140, 142 are formed in notches 144, 146 in the opposing side walls 114, 116. The tabs 140, 142 extend downwardly below the perimetrical edge 138 and are adapted to engage the lip on the opposing sides of an electrical device mounting structure, such as a mud ring (see FIG. 3). The tabs 142, 144 are flexible and move inwardly when pressed into the opening in a mud ring. After the tabs 142, 144 engage the lip of the mud ring, the securing screws 130, 132 in the diagonally opposed corners are tightened to secure the cover 110 to the mud ring.

FIG. 9 illustrates how the securing screws 142, 144 are located in recessed portions 126, 128, each of which has a base 126, 128 that slopes downwardly from the side walls 114, 116. The bases 126, 128 have apertures 134, 136 that angularly receive the securing screws 130, 132 so that the threaded end of the screws 130, 132 extend beyond the perimetrical edge 138 when fully inserted. This allows the securing screws 130, 132 to engage the lip of the mud ring.

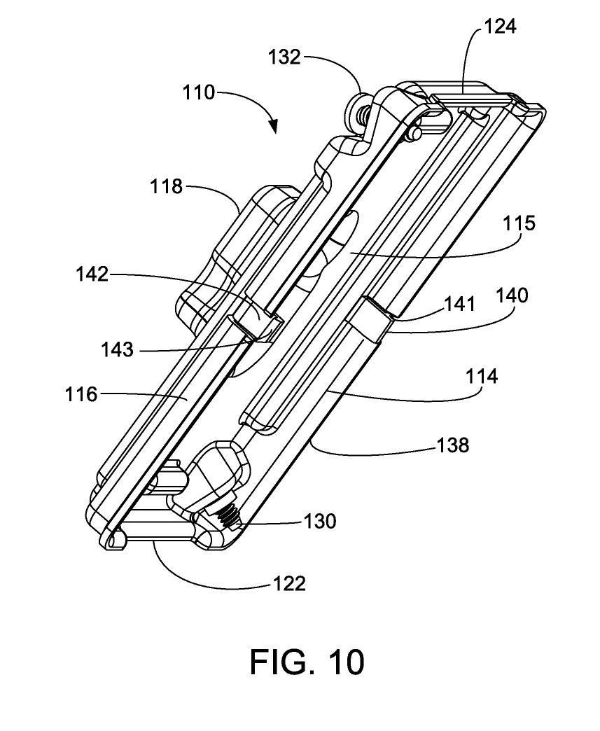

FIG. 10 shows the cover 110 in FIG. 9 viewed from the bottom and illustrates the cavity 115 formed by the cover 110. The tabs 140, 142 are shown extending beyond the perimetrical edge 138 of the cover 110 and the partially inserted securing screws 130, 132 are shown extending downwardly at an angle. From this figure, it can be appreciated how the fully inserted securing screws 130, 132 will extend beyond the perimetrical edge 138.

FIG. 10 also shows the catch 141, 143 on the end of the tabs 140, 142, which engage the electrical device mounting structure (e.g., a mud ring). The catch 141, 143 is located on the outer surface of the tab 140, 142 near the end and tapers inwardly as it approaches the end of the tab 140, 142. When the cover 110 is inserted in an opening in a mounting structure, the flexible tabs 140, 142 move inwardly until the catches 141, 143 pass the lip 92 on the mud ring (see FIG. 1A) and the top of the catches 141, 143 snap into position under the lip 92.

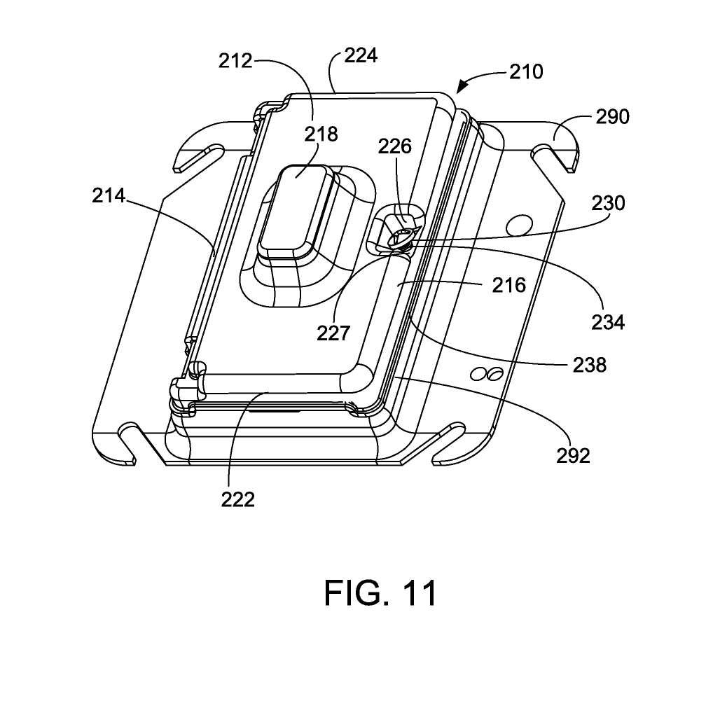

FIG. 11 shows a second embodiment of a door style protective cover plate 210 with one securing screw 230. The cover plate 210 is mounted on a mud ring 290 in a manner similar to the cover plate 10 shown in FIGS. 1, 1A, 2 and 2B. One or more tabs (not shown) extending from the perimetrical edge 238 on the left side 214 of the cover 210 engages the lip 292 on the left side of the mud ring 290 and the opposing side 216 of the cover 210 is attached to the mud ring 290 with a single securing screw 230. The securing screw 230 is located in a recessed portion 226 of the front face plate 212 near the middle of the side wall 216. The recessed portion 226 has a base 227 that slopes downwardly from the side wall 216 and an aperture in which the securing screw 230 is inserted. When the securing screw 230 is tightened, it extends beyond the perimetrical edge 238 of the cover 210 and engages the lip 292 of the mud ring 290 to secure the cover 210 in place. The cover 210 also has two closed ends 222, 224 on the top and bottom and a protrusion 218 in the center of the front face plate 212 for gripping the cover 210.

While select preferred embodiments of this invention have been illustrated, many modifications may occur to those skilled in the art and therefore it is to be understood that these modifications are incorporated within these embodiments as fully as if they were fully illustrated and described herein.

What is claimed is:

1. A protective cover for an electrical device mounting structure, wherein the protective cover comprises:
a generally rectangular plate having a front and a back and comprising a right side wall, a left side wall, a top end wall and a bottom end wall extending downwardly from the front to form a perimetrical edge having four corners;
one or more tabs extending downwardly from the perimetrical edge on one or both sides of the plate; and
one or more openings in the plate;
wherein the one or more tabs are adapted to engage an edge of the electrical device mounting structure and the one or more openings is adapted to receive a fastener for affixing the protective cover to the electrical device mounting structure.

2. A protective cover according to claim 1, further comprising a protrusion extending from the front side, wherein the protrusion is adapted for gripping the protective cover.

3. A protective cover according to claim 1, wherein the fastener is a screw.

4. A protective cover according to claim 1, wherein the one or more tabs extends from the perimetrical edge on opposite sides.

5. A protective cover according to claim 1, wherein the one or more tabs extends from the perimetrical edge on the same side.

6. A protective cover according to claim 1, wherein the one or more openings are located at corners located on the same side of the plate or are located at diagonally opposed corners.

7. A protective cover according to claim 1, wherein the one or more openings are positioned within a recessed portion of the front wherein the recessed portion has a base that is not parallel to the plate.

8. A protective cover according to claim 1, wherein the one or more tabs have an outwardly facing lip for engaging the electrical device mounting structure.

9. A protective cover according to claim 1, wherein the perimetrical edge has an outwardly extending lip.

10. A protective cover for an electrical device mounting structure, wherein the protective cover comprises:
a generally rectangular plate having a front;
a pair of end walls and a pair of side walls extending downwardly from the front of the plate to form a perimetrical edge having four corners;
at least one tab extending downwardly from the perimetrical edge of at least one side wall; and
at least one recessed portion comprising a base with an aperture adapted to receive a securing screw;
wherein the at least one tab is adapted to engage a lip around an opening in the electrical device mounting structure and the securing screw is tightened to affix the protective cover to the electrical device mounting structure.

11. A protective cover according to claim 10, wherein the recessed portion is formed at one of the corners by an indent in the two adjoining walls and the base is recessed from the front of the plate and slopes downwardly from the side wall.

12. A protective cover according to claim 11, wherein the at least one tab is on one side of the cover and the recessed portion is on the opposing side and wherein the at least one tab has an end that curves away from the cover and is adapted to engage the lip.

13. A protective cover according to claim 11 further comprising a protrusion, wherein the protrusion extends from the front of the plate and is adapted for gripping the protective cover.

14. A protective cover according to claim 10, wherein the at least one tab is on one side of the cover and the recessed portion is on the opposing side, wherein the at least one tab has an end that curves away from the cover and is adapted to engage the lip and wherein the recessed portion is formed by an indent in the side wall and the base is recessed from the front of the plate and slopes downwardly from the side wall.

15. A protective cover for an electrical device mounting structure, wherein the protective cover comprises:
a generally rectangular plate having a front;
a pair of end walls and a pair of side walls extending downwardly from the front of the plate to form a perimetrical edge having four corners;
at least one tab extending downwardly from the perimetrical edge of at least one side wall; and
at least one recessed portion comprising a base with an aperture adapted to receive a securing screw, wherein the recessed portion is formed at one of the corners by an indent in the two adjoining walls and the base is recessed from the front of the plate and slopes downwardly from the side wall,
wherein the at least one tab is adapted to engage a lip around an opening in the electrical device mounting structure and the securing screw is tightened to affix the protective cover to the electrical device mounting structure.

16. A protective cover according to claim 15, wherein two tabs are located on opposing sides of the cover and are adapted to flexibly engage the lip on opposing sides of the opening in the electrical device mounting structure.

17. A protective cover according to claim 15, wherein each tab has an outer surface with a catch that is adapted to engage the lip.

18. A protective cover according to claim 15, wherein two recessed portions are located at diagonally opposed corners.

19. A protective cover according to claim 16, wherein each of the two tabs is located in a notch in the side wall.
